(19) United States
(12) Patent Application Publication
(10) Pub. No.: US 2017/0364636 A1
(43) Pub. Date: Dec. 21, 2017

(54) METHOD AND SYSTEM FOR CONDUCTING QUESTIONNAIRE SURVEY

(71) Applicant: 9Risen Mobile Health Technology Co., Ltd., Taipei City (TW)

(72) Inventor: Mike Li-Chung CHEN, Taipei City (TW)

(21) Appl. No.: 15/404,104

(22) Filed: Jan. 11, 2017

(30) Foreign Application Priority Data
Jun. 15, 2016 (TW) 105118678

(51) Int. Cl. G06F 19/00; G06F 17/18; G09B 5/06; G09B 7/06

(52) U.S. Cl. CPC G06F 19/322; G09B 7/06; G06F 17/18; G09B 5/065

(57) ABSTRACT

A method for conducting questionnaire survey is implemented by a server coupled to a user equipment (UE). The method includes the steps of: transmitting a first questionnaire to the UE; receiving a user answer for a specific question of the first questionnaire from the UE; determining whether to transmit to the UE a second questionnaire that is associated with an issue raised in the specific question according to the user answer therefor and at least one of a physiological parameter associated with a user, an ambient parameter, or personal information of the user; and when the determination is affirmative, transmitting the second questionnaire to the UE.

### CROSS-REFERENCE TO RELATED APPLICATION

This application claims priority to Taiwanese Patent Application No. 105118678 filed on Jun. 15, 2016.

### FIELD

The disclosure relates to a method for conducting questionnaire survey.

### BACKGROUND

Nowadays, electronic questionnaire is commonly used for investigating and gathering feedback from the public. For example, a series of medical-related questionnaires provided for a user to evaluate personal health condition are usually interrelated, and may contain identical questions. However, it is time consuming for the user to repeatedly answer the same questions among different questionnaires in the series. Further, the repeatedly presented questions may cause response bias that impacts the validity of the questionnaires.

### SUMMARY

Therefore, an object of the present disclosure is to provide a method for conducting questionnaire survey.

According to one aspect of the present disclosure, the method is to be implemented by a server communicatively coupled to a user equipment (UE). The method includes the following steps: a) transmitting a first questionnaire to the UE to enable the UE to display the first questionnaire to the user; b) receiving a user answer for a first specific question of the first questionnaire from the UE; c) determining whether to transmit to the UE a second questionnaire that is associated with an issue raised in the first specific question of the first questionnaire according to the user answer for the first specific question of the first questionnaire and at least one of a physiological parameter received from the UE and associated with a physiological condition of a user, the ambient parameter received from the UE and associated with an ambient condition of an environment and personal information of the user received from the UE; and d) when the determination made in step c) is affirmative, transmitting the second questionnaire to the UE to enable the UE to display the second questionnaire to the user.

According to another aspect of this disclosure, a system for conducting questionnaire survey includes a user equipment (UE) and a server. The server is communicatively coupled to the UE for receiving therefrom physiological parameter associated with a physiological condition of a user, ambient parameter associated with an ambient condition of an environment and personal information of the user. The server is configured to store a first questionnaire and a second questionnaire that is associated with an issue raised in a first specific question of the first questionnaire and transmit the first questionnaire to the UE. The UE is further configured to display the first questionnaire to the user, to allow the user to input a user answer for the first specific question, and to transmit the user answer to the server. The server is further configured determine whether to transmit the second questionnaire to the UE according to the user answer and at least one of the physiological parameter, the ambient parameter or the personal information, and to transmit the second questionnaire to the UE when the determination is affirmative.

### BRIEF DESCRIPTION OF THE DRAWINGS

Other features and advantages of the present disclosure will become apparent in the following detailed description of the embodiments with reference to the accompanying drawings, of which:

FIG. 1 is a block diagram illustrating a server coupled to a user equipment via a communication network for implementing a method for conducting questionnaire survey according to an embodiment of the present disclosure;

FIG. 2 is a flow chart of the method for conducting questionnaire survey according to an embodiment of the disclosure;

FIG. 3 is a flow chart of the method for conducting questionnaire survey according to another embodiment of the disclosure;

FIG. 4 is a flow chart of the method for conducting questionnaire survey according to yet another embodiment of the disclosure; and

FIG. 5 is a schematic diagram illustrating an exemplary series of questionnaires stored in the server.

### DETAILED DESCRIPTION

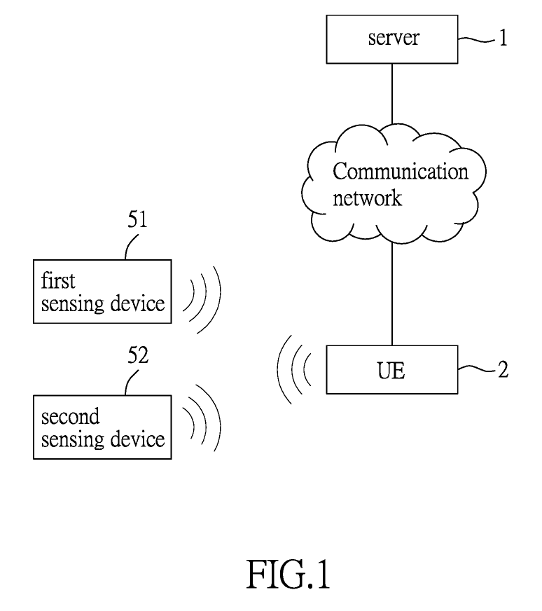

Referring to FIG. 1, a system for conducting questionnaire survey according to an embodiment of this disclosure includes a server 1, a user equipment (UE) 2, a first sensing device 51 and a second sensing device 52.

The first sensing device 51 is configured to sense physiological data associated with a physiological condition of a user (for example, blood pressure, blood sugar concentration and/or heart rate of the user). The second sensing device 52 is configured to sense ambient data associated with an ambient condition of an environment (for example, an ambient temperature and/or an ambient humidity). In one example, the first sensing device 51 is a wearable device attached to an arm of the user for sensing the blood pressure and the heart rate of the user as the physiological data, and is configured to wirelessly transmit the physiological data to the UE 2. The second sensing device 52 is disposed at a place where the user sleeps for sensing the ambient temperature and the ambient humidity as the ambient data, and is configured to wirelessly transmit the ambient data to the UE 2. In one embodiment, the second sensing device 52 is a temperature sensor disposed at the place where the user sleeps for sensing an ambient temperature every day, and wirelessly transmits the same to the UE 2 every day. In other embodiments, the first and second sensing devices 51, 52 may be omitted, and the user can input the physiological data and the ambient data to the UE 2 using, for instance, a user interface of the UE 2. In yet another embodiment, the first and second sensing devices 51, 52 may be integrated with the UE 2.

The UE 2 is communicatively coupled to the first and second sensing devices 51, 52 for receiving the physiological data and the ambient data therefrom, and is configured to allow the user to input personal information. The personal information includes, but is not limited to, gender, age and/or occupation of the user. The UE 2 is further configured to generate a physiological parameter and an ambient parameter according to the physiological data and the ambient data, respectively. For example, the UE 2 calculates an average temperature of the current month as the ambient parameter according to the ambient temperature sensed by the second sensing device 52, or directly transmits the ambient data as the ambient parameter to the server 1. Likewise, the UE 2 may directly transmit the physiological data as the physiological parameter to the server 1.

The server 1 is communicatively coupled to the UE via a communication network for receiving the physiological parameter, the ambient parameter and the personal information therefrom, and is configured to store a series of questionnaires including at least a first questionnaire and a second questionnaire. In one example, the second questionnaire is associated with an issue raised in a first specific question of the first questionnaire.

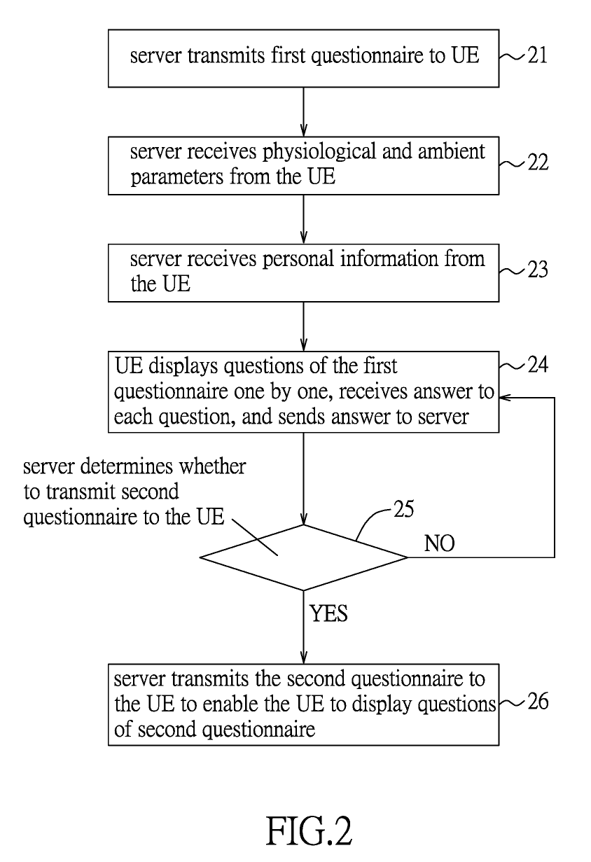

Further referring to FIG. 2, the method for conducting questionnaire survey implemented by the system according to an embodiment of this disclosure is illustrated.

In step 21, the server 1 transmits the first questionnaire to the UE 2.

In step 22, the server 1 receives from the UE 2 the physiological parameter and the ambient parameter respectively associated with the physiological data and the ambient data from the first and second sensing devices 51, 52.

In step 23, the server 1 receives the personal information of the user from the UE 2.

In step 24, the UE 2 displays one by one the questions of the first questionnaire to the user, allows the user to input a user answer for each question, and transmits the user answer to the server 1.

In step 25, when the server 1 receives the user answer for the first specific question of the first questionnaire that is associated with the second questionnaire, the server 1 determines whether to transmit the second questionnaire to the UE 2 according to the user answer for the first specific question of the first questionnaire and at least one of the physiological parameter, the ambient parameter or the personal information. In particular, the server 1 associates the first questionnaire with the second questionnaire, and determines to transmit the second questionnaire to the UE 2 when a condition pre-established in the server 1 is satisfied. In one example, the condition is associated with the user answer for the first specific question of the first questionnaire and the at least one of the physiological parameter, the ambient parameter or the personal information. The condition is satisfied when the user answer to the first specific question is a predetermined specific answer, and when the at least one of the physiological parameter, the ambient parameter or the personal information meets a predetermined set of criteria.

In step 26, when the determination made in step 25 is affirmative, the server 1 transmits the second questionnaire to the UE 2 to enable the UE 2 to display questions of the second questionnaire to the user immediately following the display of the first specific question of the first questionnaire (i.e., any remaining question of the first questionnaire will be skipped). As a result, the UE 2 displays one by one the questions of the second questionnaire to the user, rather than a next question immediately following the first specific question in the first questionnaire.

When the determination made in step 25 is negative, the UE 2 proceeds to display the next question of the first questionnaire and receive the user answer for the next question in step 24.

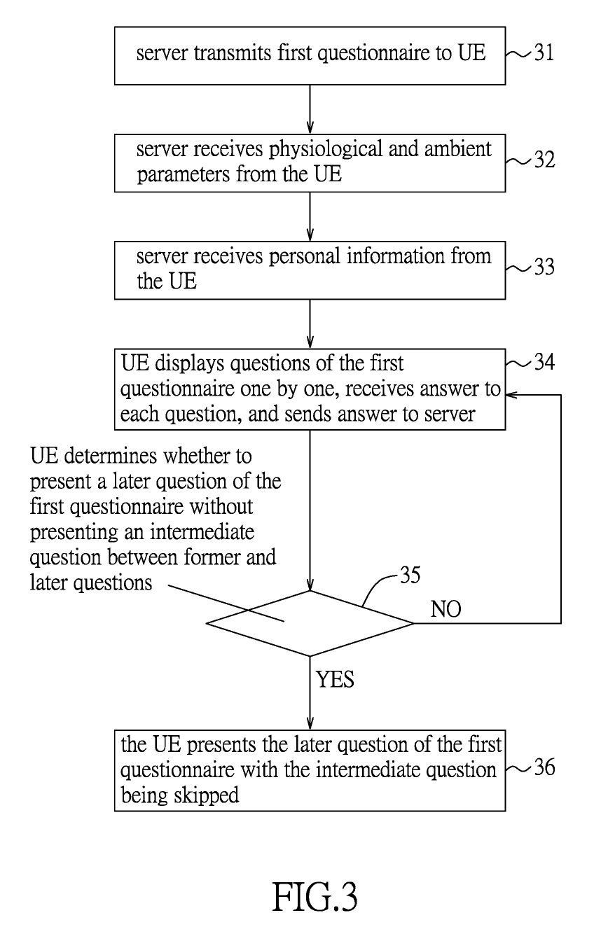

Referring to FIG. 3, the method for conducting questionnaire survey implemented by the system according to another embodiment of this disclosure is illustrated.

Steps 31 to 34 of the method in FIG. 3 are similar to steps 21 to 24 of the method in FIG. 2. In step 35, according to a user answer of a former question of the first questionnaire, the UE 2 determines whether to present a later question of the first questionnaire with an intermediate question between the former and later questions being skipped. In step 36, when the determination made in step 35 is affirmative, the UE 2 presents the later question of the first questionnaire with the intermediate question being skipped (for instance, the intermediate question may be hidden in the display, may be altogether not presented/displayed, or may be presented in a way that is not answerable by the user, etc.). Otherwise, the UE 2 returns to step 34 to display the intermediate question without skipping the same.

In other embodiments, the UE 2 determines, in step 35, whether to present a notification to notify the user to directly answer the later question and to skip the intermediate question between the former and later questions (e.g., by not answering the intermediate question) according to the user answer of the former question. The UE 2 presents the notification in step 36 when the determination made in step 35 is affirmative. Otherwise, the UE 2 returns to step 34 to display the intermediate question without displaying the notification.

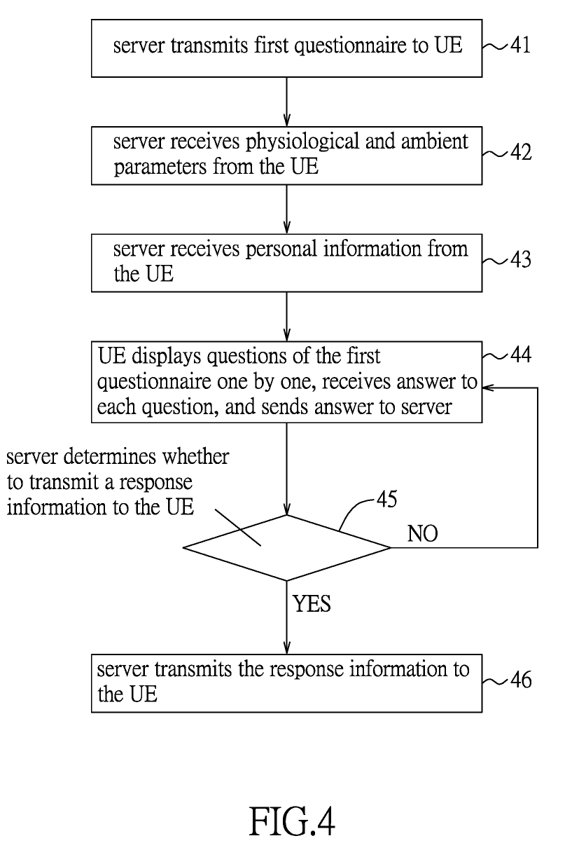

Referring to FIG. 4, the method for conducting questionnaire survey implemented by the system according to yet another embodiment of this disclosure is illustrated.

Steps 41 to 44 of the method in FIG. 4 are similar to steps 21 to 24 of the method in FIG. 2. In step 45, the server 1 determines whether to transmit a response information to the UE 2 according to the user answer for a second specific question of the first questionnaire in response to receiving the user answer for the second specific question from the UE 2. In step 46, when the determination made in step 45 is affirmative, the server 1 transmits the response information to the UE 2. The response information is an education video associated with an issue raised in the second specific question. When the determination made is step 45 is negative, the UE 2 proceeds to display a next question immediately following the second specific question in the first questionnaire, and the flow goes back to step 44 for receiving the user answer for the next question. In one implementation, the server 1 made the determination in step 45 according to a condition pre-established therein, e.g., the determination in step 45 is affirmative when the user answer for the second specific question of the first questionnaire is a predetermined specific answer.

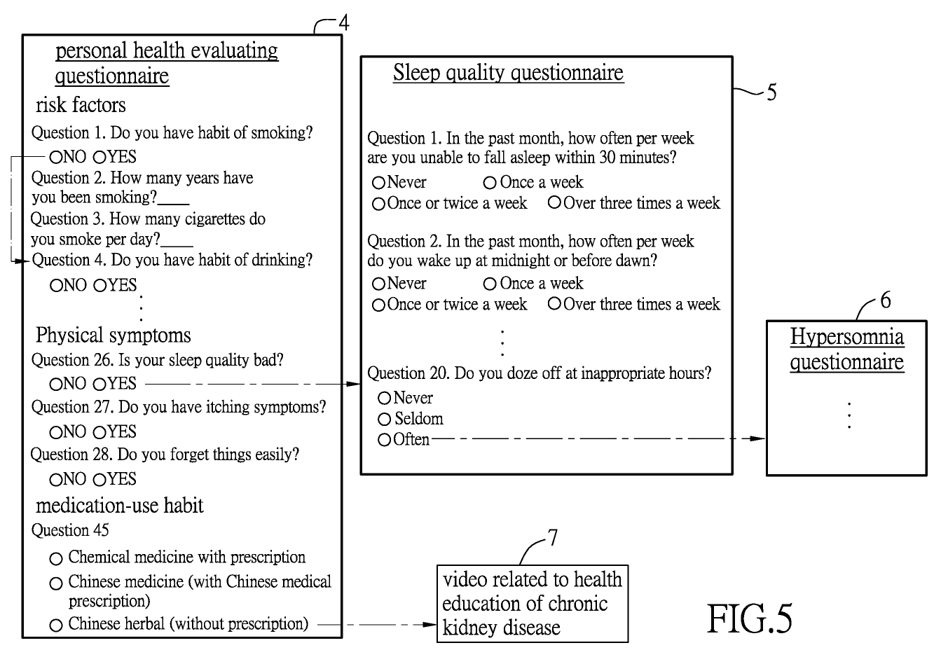

FIG. 5 shows an example of the series of questionnaires to be shown to the user in the method for conducting questionnaire survey according to the embodiments of this disclosure. In this example, the first questionnaire is a personal health evaluating questionnaire 4 and the second questionnaire is a sleep quality questionnaire 5. The series of questionnaires stored in the server 1 further includes a hypersomnia questionnaire 6.

The server 1 first transmits to the UE 2 the personal health evaluating questionnaire 4, and the UE 2 displays the same to the user such that the user can answer the questions in the personal health evaluating questionnaire 4 one by one.

After the user answers a 26^{th} question of the personal health evaluating questionnaire 4 that is related to the sleep quality of the user and that serves as the first specific question, the UE 2 transmits a user answer for the 26^{th} question to the server 1.

The server 1 then determines whether to transmit the second questionnaire, i.e., the sleep quality questionnaire 5, to the UE 2 according to the user answer for the 26^{th} question of the personal health evaluating questionnaire 4 and at least one of the physiological parameter, the ambient parameter or the personal information.

In this example, the condition pre-established in the server 1 is satisfied when the user answer to the 26^{th} question is a specific answer of “YES” the current blood pressure of the user is larger than a first threshold associated with the blood pressure, and the average temperature of the current month is higher than a second threshold associated with the average temperature. When the condition is satisfied, the server 1 determines to transmit the sleep quality questionnaire 5 to the UE 2.

Subsequently, the UE 2 is enabled to display the sleep quality questionnaire 5 to the user. The user may start to answer questions in the sleep quality questionnaire 5. The remaining questions in the personal health evaluating questionnaire 4 may be skipped.

Similarly, when the user answer for a 20^{th} question of the sleep quality questionnaire 5 is “OFTEN” and the age of the user is larger than a third threshold, the server 1 determines that another condition pre-established in the server 1 is satisfied and transmits the hypersomnia questionnaire 6 to the UE 2. The remaining questions in the sleep quality questionnaire 5 may thus be skipped.

In this way, redundant and repeated questions can be skipped, such that the user may answer the series of questionnaires efficiently and response bias may be decreased.

Further, according to a user answer of the first question of the personal health evaluating questionnaire 4 that is related to the habit of smoking of the user and that serves as the former question, the UE2 determines whether to present a later question (i.e., the fourth question which is related to the habit of drinking of the user) of the personal health evaluating questionnaire 4 with intermediate questions, i.e., the second and third questions between the first and the fourth questions, being skipped. When the user answer for the first question is “NO,” then the determination made above would be affirmative, and the UE 2 would present the fourth question with the second and third questions being skipped (e.g., not displaying the second and third questions which are related to the frequency of smoking and are irrelevant to the user who does not have the habit of smoking).

Alternatively, according to the user answer of the first question, the UE 2 determines whether to present a notification to notify the user to directly answer the fourth question and to skip the second and third questions. When the user answer for the first question is “NO,” then the determination made above would be affirmative, and the UE 2 would pre sent the notification.

In the example of FIG. 5, upon receiving the user answer for the second specific question, i.e., the 45^{th} question which is related medication-use habit of the user, of the personal health evaluating questionnaire 4, the server 1 determines whether to transmit the response information according to the user answer for the 45^{th} question. When “Chinese herbal (without prescription)” is selected as the user answer, the server 1 transmits the response information which is a video related to health education of chronic kidney disease to the UE 2.

To sum up, in the present disclosure, the server 1 associates the first questionnaire with the second questionnaire according to the condition pre-established in the server 1, and transmits the second questionnaire to the UE 2 when the condition is satisfied. In this way, the user may answer the series of questionnaires efficiently, and reliability and validity of survey result of the series of questionnaires may be increased.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for conducting questionnaire survey to be implemented by a server, the server communicatively coupled to a user equipment (UE), the method comprising steps of:
a) transmitting a first questionnaire to the UE to enable the UE to display the first questionnaire to the user;
b) receiving a user answer for a first specific question of the first questionnaire from the UE;
c) determining whether to transmit to the UE a second questionnaire that is associated with an issue raised in the first specific question of the first questionnaire according to the user answer for the first specific question of the first questionnaire and at least one of a physiological parameter received from the UE and associated with a physiological condition of a user, an ambient parameter received from the UE and associated with an ambient condition of an environment, or personal information received from the UE and associated with the user; and
d) when the determination made in step c) is affirmative, transmitting the second questionnaire to the UE to enable the UE to display the second questionnaire to the user.

2. The method of claim 1, wherein in step e), the server determines to transmit the second questionnaire to the UE when a condition pre-established in the server is satisfied, the condition being associated with the user answer for the first specific question of the first questionnaire and the at least one of the physiological parameter, the ambient parameter or the personal information.

3. The method of claim 2, wherein the condition is satisfied when the user answer for the first specific question is a predetermined specific answer, and the at least one of the physiological parameter, the ambient parameter or the personal information meets a predetermined set of criteria.

4. The method of claim 1, to be implemented further by the UE, wherein the method further comprises steps of:
e) according to an answer of a former question of the first questionnaire, determining by the UE whether to present a later question of the first questionnaire with an intermediate question between the former and later questions being skipped; and
f) when the determination made in step e) is affirmative, presenting by the UE the later question with the intermediate question being skipped.

5. The method of claim 1, to be implemented further by the UE, wherein the method further comprises steps of:
e) according to an answer of a former question of the first questionnaire, determining by the UE whether to present a notification to notify the user to directly answer a later question of the first questionnaire and to skip an intermediate question between the former and later questions; and
f) when the determination made in step e) is affirmative, presenting by the UE the notification.

6. The method of claim 1, wherein the physiological data includes one of a blood pressure, a blood sugar concentration and a heart rate of the user.

7. The method of claim 1, wherein the ambient data includes one of an ambient temperature and an ambient humidity.

8. The method of claim 1, the method further comprising steps of:
e) determining whether to transmit a response information to the UE according to a user answer for a second specific question of the first questionnaire in response to receiving the user answer for the second specific question from the UE; and
f) when the determination made in step e) is affirmative, transmitting the response information to the UE.

9. The method of claim 8, wherein the response information is an education video associated with an issue raised in the second specific question.

10. A system for conducting questionnaire survey comprising:
a user equipment (UE); and
a server communicatively coupled to said UE for receiving therefrom physiological parameter associated with a physiological condition of a user, ambient parameter associated with ambient condition of an environment and personal information of a user, and configured to store at least a first questionnaire and a second questionnaire that is associated with an issue raised in a first specific question of the first questionnaire and transmit the first questionnaire to said UE,
wherein said UE is further configured to display the first questionnaire to the user, to allow the user to input a user answer for the first specific question, and to transmit the user answer to said server,
wherein said server is further configured to determine whether to transmit the second questionnaire to said UE according to the user answer and at least one of the physiological parameter, the ambient parameter or the personal information, and to transmit the second questionnaire to said UE when the determination is affirmative.

11. The system as claimed in claim 10, wherein said sever is configured to associate the first questionnaire with the second questionnaire and determine to transmit the second questionnaire to said UE when a condition pre-established in said server is satisfied, the condition being associated with the user answer for the first specific question of the first questionnaire and the at least one of the physiological parameter, the ambient parameter or the personal information.

12. The system as claimed in claim 11, wherein the condition is satisfied when the user answer for the first specific question is a predetermined specific answer, and the at least one of the physiological parameter, the ambient parameter or the personal information meets a predetermined set of criteria.

13. The system as claimed in claim 10, wherein said UE is configured to determine whether to present a later question of the first questionnaire with an intermediate question between the former and later questions being skipped according to an answer of a former question of the first questionnaire, and
wherein said UE is further configured to present the later question with the intermediate question being skipped when the determination is affirmative.

14. The system as claimed in claim 10, wherein said UE is configured to determine whether to present a notification to notify the user to directly answer a later question of the first questionnaire and to skip an intermediate question between the former and later questions according to an answer of a former question, and
wherein said UE is further configured to present the notification when the determination is affirmative.

15. The system as claimed in claim 10, wherein the physiological data includes one of a blood pressure, a blood sugar concentration and a heart rate of the user.

16. The system as claimed in claim 10, wherein the ambient data includes one of an ambient temperature and an ambient humidity.

17. The system as claimed in claim 10, wherein said server is configured to determine whether to transmit a response information to said UE according to a user answer for a second specific question of the first questionnaire in response to receiving the user answer for the second specific question from said UE, and
wherein said server is further configured to transmit the response information to said UE when the determination is affirmative.

18. The system of claim 17, wherein the response information is an education video associated with an issue raised in the second specific question.

19. The system of claim 10, further comprising:
a first sensing device for sensing physiological data of the user that is associated with the physiological condition of the user, and communicatively coupled to said UE for transmitting the physiological data thereto; and
a second sensing device for sensing ambient data that is associated with the ambient condition of the environment, and communicatively coupled to said UE for transmitting the ambient data thereto;
wherein said UE generates the physiological parameter according to the physiological data, and generates the ambient parameter according to the ambient data.

20. The system of claim 19, wherein said UE generates the physiological parameter by taking an average of the physiological data, and generates the ambient parameter by taking an average of the ambient data.
